(19) United States
(12) Patent Application Publication
(10) Pub. No.: US 2002/0103735 A1
(43) Pub. Date: Aug. 1, 2002

(54) Certificate of international billing clearance and system

(76) Inventor: Scott Michael Sweeney, Reno, NV (US)

Correspondence Address: Scott Sweeney, 8455 offenhauser, #1038, Reno, NV, 89511, US

(21) Appl. No.: 09/771,573

(22) Filed: Jan. 30, 2001

(51) Int. Cl. G06F 17/60

(52) U.S. Cl. 705/35

(57) ABSTRACT

The Certificate of International Billing Clearance is a financial tool that allows for the rights of billing and collection to be traded across national borders. The International Debit Exchange provides the computerized transaction management and accounting system needed to process the certificates. The resulting system allows for firms and individuals living and working in a host country on an extended basis to settle payment of bills through a host country or country of choice rather than back to a home country.

Background to the Invention

In the global economy there are a number of deficiencies in the financial infrastructure for credit management and billing clearance. These deficiencies have surfaced due to recent demographic and economic trends. First, the number of dual-economic firms and individuals, that is, firms and individuals who relocate or branch out to more than one country on an extended basis, has skyrocketed. In the United States alone, the number of non-government American citizens living abroad now exceeds four million (U.S. State Department statistic). Large multinational corporations that once dominated the international markets have been joined by thousands of much smaller businesses extending beyond their home country's borders for the first time.

The present international credit card system, which was originally designed for tourism and short-term business travel, has been less than adequate for firms on multi-year contracts and individuals on multi-year work visas. It may be necessary as well as convenient for international firms, businessmen, journalists, scholars, and students to receive credit from financial institutions in countries other than their home countries when they are abroad for years at a time. However, it is extremely difficult to receive credit in a 2^{nd} or host country without significant amounts of collateral, letters of credit, or cosigners/guarantors within the 2^{nd} (host) country. In many countries, including the United States, there may be an inherent financial distrust of foreign nationals due to the possibility of firms or individuals accumulating substantial debts and then returning back to their home countries without payment. An international civil court system does not exist and cross-border debit claims are extremely difficult to settle without bilateral agreements and tremendous amounts of expensive litigation. For businesses, sales transactions are often too large to be processed on credit cards and are complicated by electronic wire transfers, letters or lines of credit, instant financing, and escrow. The most sophisticated billing clearance systems are plagued by manual processing, paper invoices, and redundant systems.

One possible solution to many of these deficiencies may be to create a financial infrastructure whereby financial institutions may issue credit without regard to financial distrust due to a firm's out-of-country home office or an individual's national origin, citizenship, or permanent resident status. This solution may also allow firms or individuals living and working in a host country on an extended basis to settle payment of their bills through the host country or country of their choice rather than through complicated, time-consuming, and expensive monetary payments back to one's home country.

Brief Summary of the Invention

It is the purpose of this present invention to provide the unique financial tool for an international billing clearance system wherein one country's financial institutions or designated agents can exchange the rights of billing and collection with those in another country and the system to complete such a trade.

### BRIEF DESCRIPTION OF THE SEVERAL VIEWS OF THE DRAWING

In the present invention a unique certificate of international billing clearance (CIBC) is provided for use in an international debit exchange (INDEBEX) system.

FIG. 1 is a plan view of the front of the Certificate of International Billing Clearance (CIBC).

FIG. 2 is a plan view of the rear of the Certificate of International Billing Clearance (CIBC).

FIG. 3 is a flowchart depicting the flow of interactions involved in a simplified international billing clearance transaction through the international debit exchange (INDEBEX) system.

### DETAILED DESCRIPTION OF THE INVENTION

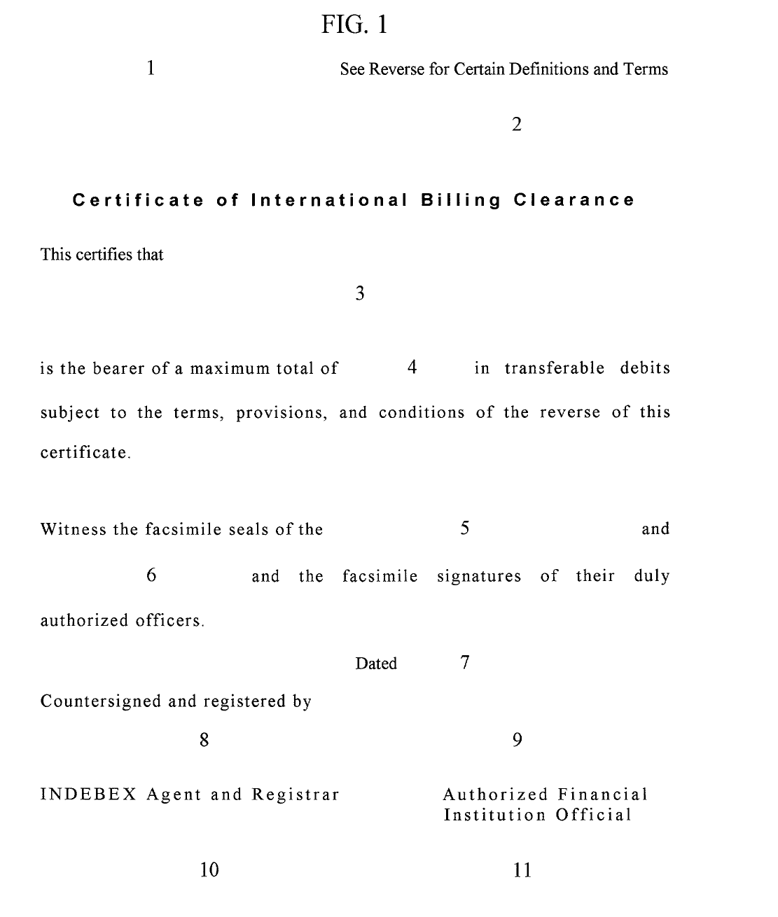

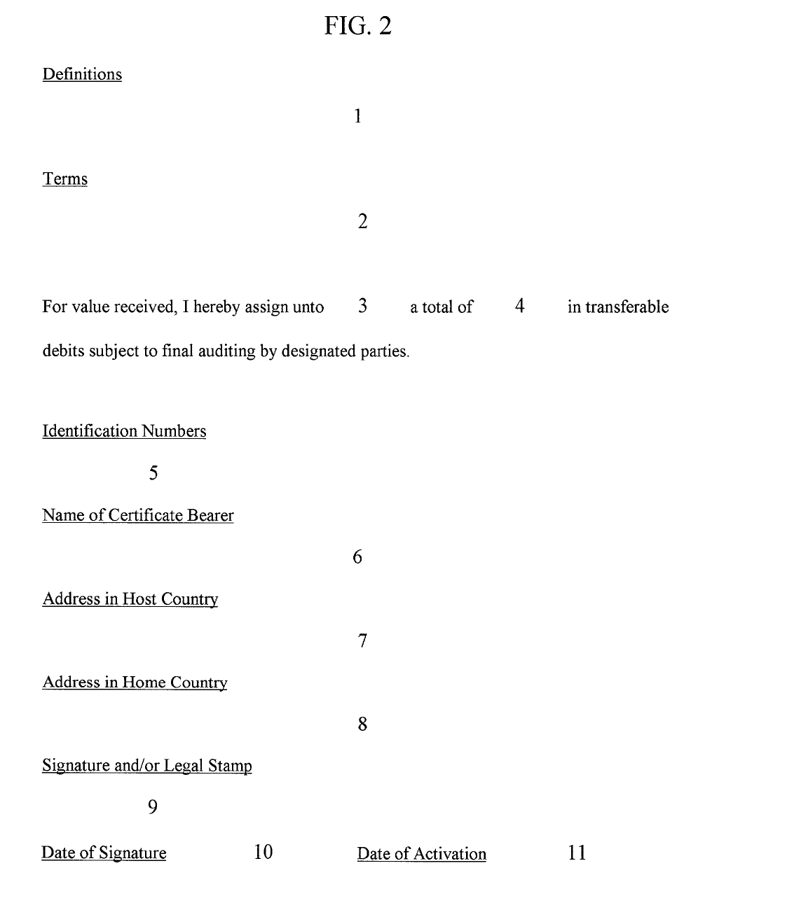

The invention depicted in FIG. 1 and FIG. 2 is a financial tool that serves the inverse function to currency and credits, and circulates in a direction opposite to cash flow. Like currency, it provides a common medium of exchange and is controlled by financial institutions. However the invention is not normally activated until there is an intent by the firm or individual named in the certificate to conclude business in one country, Country A, and proceed to another country, Country B, without clearing the deficit balance which may have accumulated under credit terms in Country A.

The Country A financial institution initiates the CIBC at the time the firm or individual is applying for credit. FIG. 1 depicts the physical form of the front of the CIBC and the basic information that must accompany the certificate:

1) The name of the financial institution initiating the CIBC.

2) The unique CIBC alpha-numeric identifier. This identifier is obtained through the INDEBEX organization and managed by the INDEBEX system.

3) The name of the firm or individual responsible for the provisions of the CIBC.

4) The maximum total of debits that the firm or individual is responsible for under the terms of the CIBC. In most cases, this will equal the amount of credit offered by the financial institution.

5) The name of the financial institution initiating the CIBC.

6) The name of the INDEBEX organization.

7) The date that the CIBC is initiated.

8) The signature of the INDEBEX agent or registrar.

9) The signature of the authorized financial institution official.

10) The seal of the INDEBEX organization.

11) The seal of the financial institution.

The Country A financial institution and applicant complete the CIBC by adding information to the rear of the certificate. FIG. 2 depicts the physical form of the rear of the CIBC and the additional information that must accompany the certificate:

1) Definitions of words or phrases that are particular to the CIBC and INDEBEX process.

2) The terms of the CIBC.

3) The name of the financial institution initiating the CIBC.

4) The net unpaid deficit balance at the time of CIBC activation. This information is left blank until the time of activation.

5) The CIBC applicant's social security number, passport number, or other identifying numbers as applicable.

6) The name of the CIBC applicant.

7) The CIBC applicant's address in the host country (Country A).

8) The CIBC applicant's address in the home country. Without further notice by the applicant at the time of CIBC activation, this may assumed to be Country B.

9) The CIBC applicant's signature. In some countries (Japan, for example), a legal stamp may be used in lieu of an actual signature.

10) The date of CIBC applicant's signature.

11) The date of CIBC activation. This information is left blank until the time of activation.

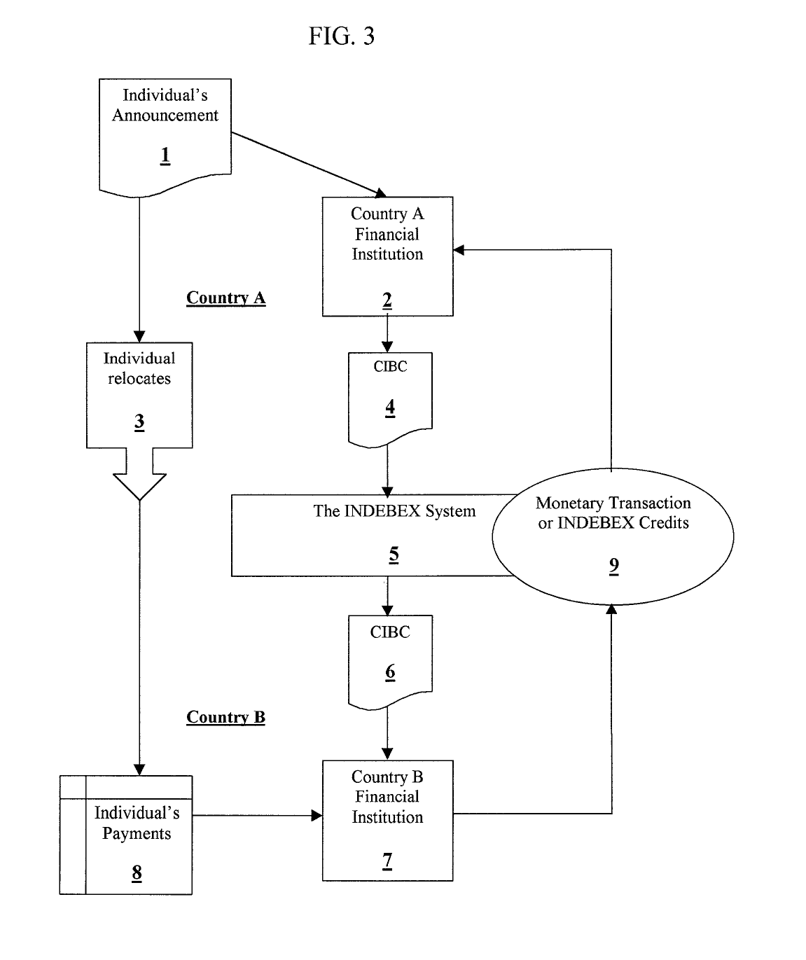

FIG. 3. depicts a simplified transaction using the CIBC as it is processed through the accompanying system (INDEBEX) on or about the time of activation. The individual in this case has already received a credit line from the Country A financial institution, and he has a net deficit balance. A pre-activated CIBC is on hand at the financial institution. The flowchart begins at the time the individual intends to relocate from Country A to Country B:

1) The individual announces to the Country A financial institution his intent to leave Country A without paying off the deficit balance.

2) The Country A financial institution closes off the individual's line of credit and activates the CIBC. This activation includes the completing of FIG. 2, the rear of the CIBC, with information about the net unpaid deficit balance at the time of CIBC activation (FIG. 2, reference number 4) and the date of CIBC activation (FIG. 2, reference number 11).

3) The individual relocates to Country B.

4) The CIBC is sent, either physically or electronically, to the INDEBEX system.

5) The INDEBEX system facilitates and manages the CIBC transaction.

6) A comparable CIBC is sent to a Country B financial institution.

7) The Country B financial institution obtains the right for billing and collection.

8) The individual continues payment on the deficit balance (plus any additional transaction, service and interest charges) to the Country B financial institution.

9) The Country B financial institution completes the transaction by paying for the individual's CIBC either through monetary payment or INDEBEX credits.

The INDEBEX system utilizes membership from global financial institutions, CIBC transaction agents, and any other organizations which provide financial credit and desires membership in the INDEBEX. Since a firm or individual may have more than one credit source, it is quite possible that they also may have multiple CIBC's in place in a home or host country. During the period of CIBC activation, the Country A and B financial institutions may use conventional hardware, software and the Internet to complete the transaction process. Private communications lines and specialized INDEBEX software may be used by financial institutions to improve both speed and security.

The INDEBEX provides the private, centralized, and computerized transaction management and accounting system needed to process the CIBC's. The most vital information to be passed from the Country A financial institution to INDEBEX includes the unique CIBC alpha-numeric identifier, deficit balance, firm or individual name and other identifiers, credit-relevant information, and name of Country B. The private exchange will work on auction principles of trading to establish the market price of a CIBC according to the current buying and selling interests. If such interests are out of balance, INDEBEX officials may intercede to maintain an orderly market. Commissions received by INDEBEX are added to the purchase price to arrive at the net price to the Country B financial institution. In order to complete the transaction, INDEBEX also manages and accounts for INDEBEX credits as desired in lieu of monetary transactions between financial institutions.

The pre-activated CIBC may be brought into existence as part of the normal credit application process. Appended to the certificate may be additional legal documents allowing the transfer of contractual rights of billing and collection in both Country A and Country B (if the applicant declares a “home” country). Government-regulated legal documentation may require additional translation and signatures or legally recognized stamps. Once signed, the CIBC can be activated and traded on the INDEBEX system, either in paper, facsimile, electronic, or other format. Financial institutions and CIBC applicants can use the INDEBEX database to research the daily credit interest rates and terms of other INDEBEX members in participating countries.

The most likely reasons for trading the certificate of international billing clearance are:

(1) The applicant announces his intention to change countries on an extended basis.

(2) The applicant departs Country A for Country B on an extended basis without announcement. If the applicant's credit payments are in default, the Country A financial institution may be within its rights to add penalties to the principal prior to activating and trading the CIBC.

(3) The Country A financial institution may desire to alter its level of default risk by increasing or decreasing its number of CIBC's. CIBC's are intended to be financial tools, not investment instruments. However, it is possible that some financial institutions may capitalize CIBC's into government-approved financial securities for investment purposes and as a method for sharing risk.

As long as legal standards for both Country A and Country B are met, as well as the terms of the original credit contract between host financial institution and applicant, no additional approval from the applicant may be necessary prior to activation. However, receipt of the certificate by a Country B financial institution may not necessitate further extension or alteration of the terms of credit, including significant credit interest rate increases, without express permission of the applicant. The CIBC may be retired upon a zero deficit balance and approval of the applicant. Billing and collection transferal may also be rolled into a new credit application, and the CIBC replaced or retired.

In view of the foregoing, it should be apparent that a novel means has been provided by which a foreign firm or individual may receive credit in a home or host country and have the rights of billing and collection transferred to any other country as necessary through an international debit exchange system.

While a preferred embodiment of the present invention has been described in detail, various modifications, alterations, or changes may be made without departing from the spirit of the present invention. Such modifications, other than cosmetic, may include, but are not limited to: 1) government or legally-required changes, 2) language translation, 3) a change in representation from physical to electronic or other communications media form, and 4) a variation of the invention into a government-approved financial security. Modifications may also occur due to changes in the means of transaction, international accounting standards, and general acceptance of a creditor “code of conduct” or a credit applicant “bill of rights.”

What is claimed is:

1. A unique, 2-sided certificate of international billing clearance for use with the granting of credit to domestic and foreign firms and individuals residing in a host country on an extended but not necessarily permanent basis, having unique information and markings, and which can be traded in a unique international debit exchange system as necessary, said certificate, in and of itself, constituting a standardized and simplified title to bill and collect up to a maximum limit established by an original crediting organization.

2. A unique international debit exchange system to process the invention of claim 1 wherein billing clearance is accomplished between two or more countries.
